(19) United States
(12) Patent Application Publication
(10) Pub. No.: US 2017/0323283 A1
(43) Pub. Date: Nov. 9, 2017

(54) SYSTEM AND METHOD FOR SPLITTING A CARD DATA STRUCTURE

(71) Applicant: PAYPAL, INC., San Jose, CA (US)

(72) Inventors: Michael Charles Todasco, San Jose, CA (US); Geetha Kuppuswamy, San Jose, CA (US); Sumeet Ahuja, San Jose, CA (US); Anand Lakshmanan, San Jose, CA (US); Shaun Hulley, Sydney (AU); Alex McClure, Sachse, TX (US)

(21) Appl. No.: 15/144,881

(22) Filed: May 3, 2016

(51) Int. Cl. G06Q 20/22; G06K 19/07; G06Q 20/34

(52) U.S. Cl. CPC G06Q 20/29; G06Q 20/3433; G06K 19/072; G06Q 20/342

(57) ABSTRACT

Methods, systems, and computer program products are included for splitting a gift card by generating one or more other gift cards. A transaction processor receives a request to split a first value that corresponds to a first data structure, the request including a first identifier that is associated with the first data structure. Responsive to the request, the transaction processor generates a second data structure. The transaction processor assigns a second identifier and a second value to the second data structure. The transaction processor receives a second request that includes the second identifier and a third value. The transaction processor reduces the third value by the second value.

### BACKGROUND

### Field of the Invention

The present disclosure generally relates to data structures and data processing.

### Related Art

Gift cards, which may also include gift certificates, are commonly used for purchasing goods and services. Traditionally, a gift card is purchased for a particular amount, which is used to prepay for a value that is associated with the card. Once the gift card is prepaid to a particular value, the gift card may be used for purchases until the prepaid value is exhausted. In many instances, but not always, gift cards are gifted to recipients, who may use the gift cards at various retailers and other businesses.

Conventional gift cards are associated with the prepaid value via a gift card number that is displayed on the card and/or stored on a magnetic strip, bar code, or other electronic storage medium. Accordingly, merchants may access the gift card number from the gift card to perform in-store and/or online transactions using the gift card.

Gift cards generally are used as an alternative to cash or other payment methods, and commonly come in two varieties: open loop and closed loop. Open loop gift cards may be issued by banks or credit card companies and are typically redeemable at a variety of retailers. Closed loop cards may be issued by particular retailer and limited for use at the particular retailer.

### BRIEF DESCRIPTION OF THE DRAWINGS

The present invention is illustrated by way of example and not limitation in the figures of the accompanying drawings.

FIG. 1 is a block diagram illustrating a system architecture for splitting a gift card, in accordance with various examples of the present disclosure.

FIG. 2 is a block diagram illustrating a system architecture for splitting a gift card, in accordance with various examples of the present disclosure.

FIG. 3 is a flow diagram illustrating a method for splitting a gift card, in accordance with various examples of the present disclosure.

FIG. 4 is a block diagram illustrating a computer system suitable for implementing one or more computing devices.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

According to the various aspects of the present disclosure, a method, system, and computer program product are discussed for splitting a prepaid value of a gift card among a plurality of gift cards. For example, a gift card that is associated with a $100 prepaid value may be split into two (or more) gift cards that each have a smaller prepaid value, such as a first gift card that is associated with a $75 prepaid value and a second gift card that is associated with a $25 prepaid value.

Splitting a gift card may be performed by generating one or more data structures corresponding to the gift cards of smaller value. Identifiers and prepaid values are generated and associated with the generated one or more data structures. The generated identifiers may be provided at retailers and/or other businesses to process transactions up to the prepaid values associated with the data structures. The generation of data structures, identifiers, and prepaid values is performed by one or more computing devices, and the generated data structures, identifiers, and prepaid values are stored on one or more storage devices.

The embodiments disclosed herein provide advantages to conventional gift card techniques. For example, the techniques for splitting gift cards improve the data processing corresponding to gift cards to provide features not available in conventional computing devices. Further, the embodiments disclosed herein address the problem of a prepaid value for a gift card being locked to the particular gift card. This problem associated with conventional computing devices is addressed by providing additional data structures to which the prepaid value may be allocated. Accordingly, these embodiments provide a technical solution that addresses a problem arising in the area of data processing corresponding to gift cards. Of course, it is understood that these features and advantages are shared among the various examples herein and that no one feature or advantage is required for any particular embodiment.

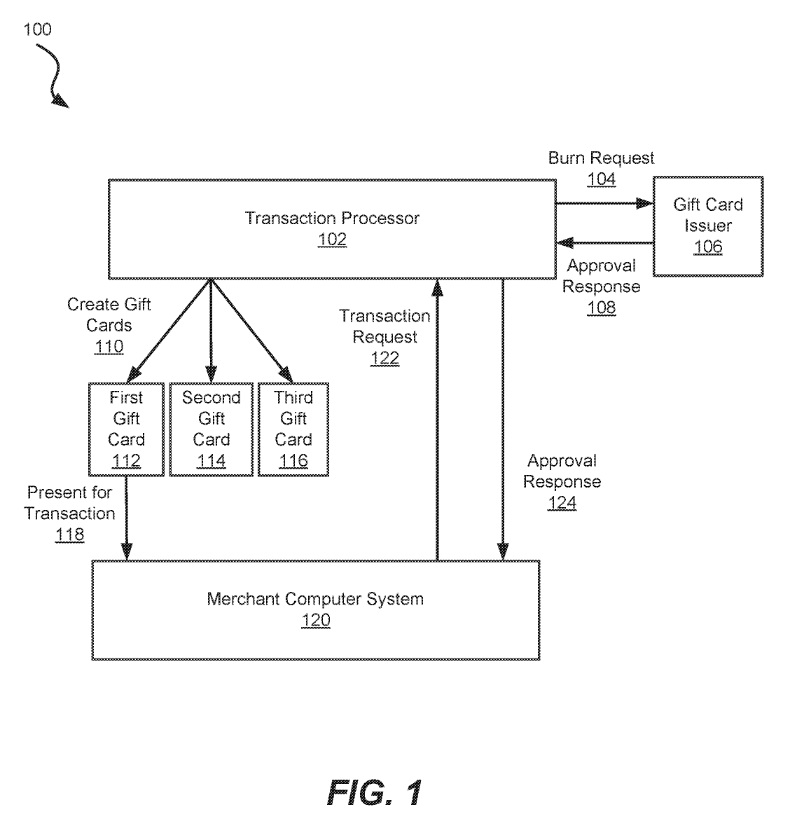

FIG. 1 illustrates a system architecture 100 for splitting a gift card, in accordance with various examples of the present disclosure. System architecture 100 includes a transaction processor 102, a gift card issuer 106, and a merchant computer system 120 that each is structured as one or more computing devices. These computing devices are communicatively coupled by a network, which may include additional computing devices that are structured to route information between the computing devices.

The transaction processor 102 is structured to receive requests from users to split gift cards. These requests may each include an identifier of a gift card that a user wishes to split into multiple gift cards. Additionally, each request may include an allocation of the prepaid funds of the gift card that specifies how to distribute the funds among the multiple gift cards.

In some examples, the transaction processor 102 receives a gift card split request via the network from a web interface or other application provided by a user computing device. The transaction processor 102 is structured to process the request for a gift card split by communicating a burn request 104 to a gift card issuer 106 via the network. The burn request 104 is structured to include the received gift card identifier.

The gift card issuer 106 is structured to evaluate the request to determine whether the identifier corresponds to a valid gift card, and if so, whether there is a prepaid value associated with the gift card sufficient to satisfy the request. In some examples, the gift card issuer 106 performs a query of a data store to match the received identifier with one or more identifiers stored in the data store. Accordingly, if a match is located, the gift card issuer 106 may approve the request and mark the located entry in the data store corresponding to the gift card as used and/or invalid. The gift card issuer 106 may then communicate an approval response 108 to the transaction processor 102. In the alternative, the gift card issuer 106 may deny the request if there are insufficient funds or if the received identifier does not match at least one stored identifier.

Upon receiving the approval response 108, the transaction processor 102 is structured to create data structures for the multiple gift cards at action 110. In the present example, the data structures include a data structure for a first gift card 112, a data structure for a second gift card 114, and a data structure for a third gift card 116. Each data structure may include a uniquely generated identifier and a prepaid value. The prepaid value assigned to each gift card may be assigned based on a received allocation from the request provided to the transaction processor 102. While the present example identifies the creation of three gift cards, in other examples there may be another amount of gift cards created (e.g., two). In some examples, the number of gift cards created may be configured by a user.

The transaction processor 102 is structured with one or more data stores that store the generated data structures and their assigned identifiers and prepaid values. For example, the data stores may be structured as relational databases or flat files, which store entries corresponding to the gift cards. In some examples, each identifier of a gift card is stored as a primary key in a database, and each identifier is associated with one or more attributes that associate data values with each identifier. An associated data value may include, for example, the prepaid value corresponding to the gift card. Accordingly, in some examples, the data structure for a gift card may comprise a primary key and one or more data values that are associated with the primary key.

In some examples, the gift cards 112, 114, and/or 116 are virtual gift cards comprising the gift card data structures, without also including corresponding physical gift cards. In other examples, physical gift cards may be generated corresponding to each data structure. The physical gift cards may be provided to one or more users. In some examples, each physical gift card may be assigned an identifier that is a same identifier used in the gift card's corresponding data structure. In other examples, each physical gift card is assigned an identifier that maps to an identifier of the gift card's corresponding data structure. The mapping may be a stored mapping or an algorithmic mapping that computes the identifier of the data structure based on performing an algorithm on the identifier of the physical gift card.

Once the gift cards 112, 114, and 116 are created, the transaction processor 102 is structured to process transactions corresponding to the gift cards. As illustrated, a gift card, such as the first gift card 112 may be presented for a transaction at a merchant computer system 120 by a user at action 118. The merchant computer system 120 is structured to communicate a transaction request 122 to the transaction processor 102.

The transaction request 122 is structured to include the identifier corresponding to the first 112 gift card and a transaction amount. The identifier may be input at the merchant computer system 120 by a user via a computer interface, such as a web browser or graphical user interface of another application. The identifier may be input by scanning a magnetic stripe, bar code, smart chip, or other identifier storage device.

The transaction processor 102 is structured to receive the transaction request 122. The transaction processor 102 may verify the transaction request 122 by comparing the received identifier with one or more identifiers corresponding to gift cards. The transaction processor 102 may therefore identify the transaction request 122 as corresponding to the first gift card 112 based on a matching between the identifier received in the transaction request 122 with the identifier of the first gift card 112 that is stored in a data structure. The transaction processor 102 may also compare the prepaid value of the first gift card 112 to the transaction amount, and if the funds are sufficient, apply the transaction amount to the prepaid value by debiting the transaction amount from the prepaid value. In some examples, a transaction request 122 may correspond to a credit operation, such as when an item is returned to a merchant. Accordingly, the merchant computer system, 120 may also apply transaction amounts to a prepaid value by crediting the transaction amount to the prepaid value.

After applying the transaction amount to the prepaid value of the first gift card 112, the transaction processor 102 is structured to communicate an approval response 124 to the merchant computer system 120. In some examples, communications between the transaction processor 102 and the merchant computer system 120 are routed through one or more intermediary computing devices, such as one or more acquirer computing systems and/or one or more network computing systems. In other examples, communications may be sent directly between the transaction processor 102 and the merchant computer system 120.

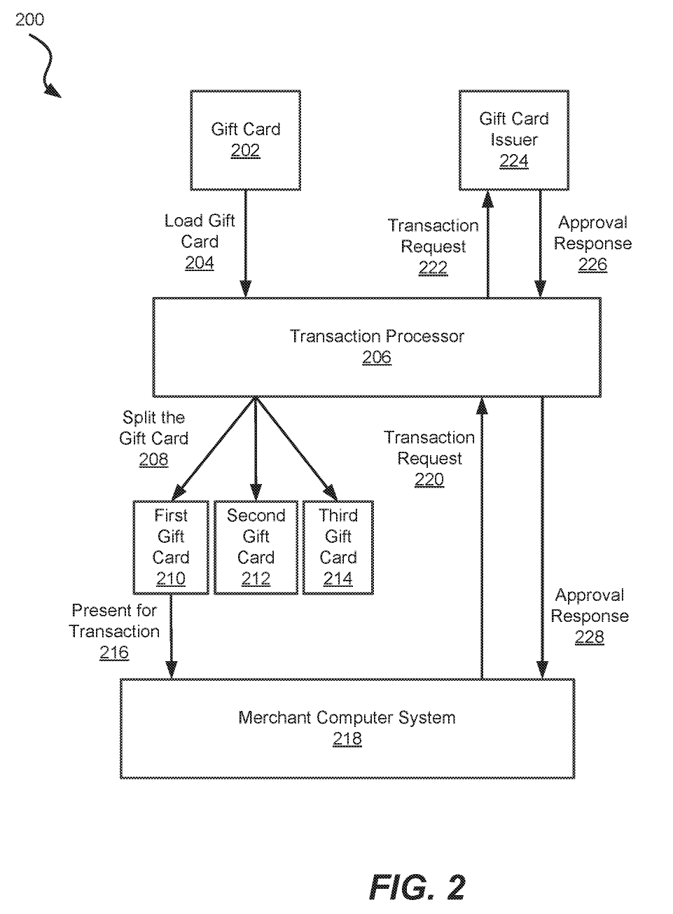

FIG. 2 illustrates a system architecture 200 for splitting a gift card, in accordance with various examples of the present disclosure. System architecture 200 includes a transaction processor 206, a merchant computer system 218, and a gift card issuer 224 that each is structured as one or more computing devices. These computing devices are communicatively coupled by a network, which may include additional computing devices that are structured to route information between the computing devices.

The system architecture 200 includes a gift card 202, which may be structured as a physical card that includes a magnetic stripe, bar code, personal account number, and/or other feature that may be used to uniquely identify the gift card 202. In other examples, the gift card 202 is a virtual gift card that is not associated with a physical card, but is implemented by one or more data structures stored on one or more computing systems.

In the present example, the transaction processor 206 is structured to receive a request from a user to split the gift card 202 into a plurality of gift cards. The request may include an identifier of the gift card 202 and an indication of a desired re-allocation of the prepaid funds of the gift card 202 into one or more other gift cards.

In some examples, the request is received by a web interface or other application provided by a user computing device. The transaction processor 206 is structured to process the request by performing an action 204 to load the gift card 202 into one or more data stores corresponding to the transaction processor 206. In some examples, the transaction processor 206 loads the gift card at action 204 by creating a data structure corresponding to the gift card 202, assigning the identifier and the prepaid value to the data structure, and associating the data structure with the user that initiated the request. In some examples, the data structure comprises one or more database entries.

The transaction processor 206 is structured to create data structures for the one or more gift cards into which the prepaid value of the gift card 202 is to be allocated at action 208. In the present example, the data structures include a data structure for a first gift card 210, a data structure for a second gift card 212, and a data structure for a third gift card 214. Each data structure may include a uniquely generated identifier and a prepaid value. The prepaid value assigned to each gift card may be assigned based on a received allocation from the request provided to the transaction processor 206 by the user. Each data structure that is generated may further include a root code or other link that maps to the data structure created during the loading of the gift card 202 at action 204. While the present example identifies the creation of three gift cards, in other examples there may be another amount of gift cards created (e.g., two). In some examples, the number of gift cards created may be configured by a user.

The transaction processor 206 is structured with one or more data stores that store the generated data structures. For example, the data stores may be structured as relational databases or flat files, which store entries corresponding to the gift cards. In some examples, each identifier of a gift card is stored as a primary key in a database, and each identifier is associated with one or more attributes that associate data values with each identifier. An associated data value may include, for example, the prepaid value corresponding to the gift card. Accordingly, in some examples, the data structure for a gift card may comprise a primary key and one or more data values that are associated with the primary key.

In some examples, the gift cards 210, 212, and/or 214 are virtual gift cards comprising the gift card data structures, without also including corresponding physical gift cards. In other examples, physical gift cards may be generated corresponding to each data structure. The physical gift cards may be provided to one or more users. In some examples, each physical gift card may be assigned an identifier that is a same identifier used in the gift card's corresponding data structure. In other examples, each physical gift card is assigned an identifier that maps to an identifier of the gift card's corresponding data structure. The mapping may be a stored mapping or an algorithmic mapping that computes the identifier of the data structure based on performing an algorithm on the identifier of the physical gift card.

Once the gift cards 210, 212, and 214 are created, the transaction processor 206 is structured to process transactions corresponding to the gift cards. As illustrated, a gift card, such as the first gift card 210 may be presented for a transaction at a merchant computer system 218 by a user at action 216. The merchant computer system 218 is structured to communicate a transaction request 220 to the transaction processor 206.

The transaction request 220 is structured to include the identifier corresponding to the first gift card 210 and a transaction amount. The identifier may be input at the merchant computer system 218 by a user via a computer interface, such as a web browser or graphical user interface of another application. The identifier may be input by scanning a magnetic stripe, bar code, smart chip, or other identifier storage device.

The transaction processor 206 is structured to receive the identifier of the first gift card 210 and the transaction amount that are provided in the transaction request 220. The transaction processor 206 is structured to determine the parent gift card of the first gift card 210, such as by accessing a root code or other association/mapping of the first gift card 210 that links the first gift card 210 to the gift card 202 that is loaded at action 204. Accordingly, the transaction processor 206 determines the identifier of the gift card 202 by reading the identifier from the data structure created for the gift card 202. Next, the transaction processor 206 provides the identifier corresponding to the gift card 202 and the transaction value from the transaction request 220 to the gift card issuer 224 in a transaction request 222. The gift card issuer 224 is structured to process a transaction using the gift card 202, by applying the transaction value to the prepaid value of the gift card 202 that is stored by the gift card issuer 224. Once the gift card issuer 224 has applied the transaction value to the prepaid value of the gift card 202, the gift card issuer 224 communicates an approval response 226 to the transaction processor 206.

Once the transaction processor receives the approval response 226, the transaction processor 206 is structured to apply the transaction amount to the prepaid value assigned to the first gift card 210. After applying the transaction amount to debit or credit the prepaid value assigned to the first gift card 210, as appropriate, the transaction processor 206 communicates an approval response 228 to the merchant computer system 218 indicating that the transaction has been successfully processed.

In some examples, communications between the transaction processor 206 and the merchant computer system 218 are routed through one or more intermediary computing devices, such as one or more acquirer computing systems and/or one or more network computing systems. In other examples, communications may be sent directly between the transaction processor 206 and the merchant computer system 218.

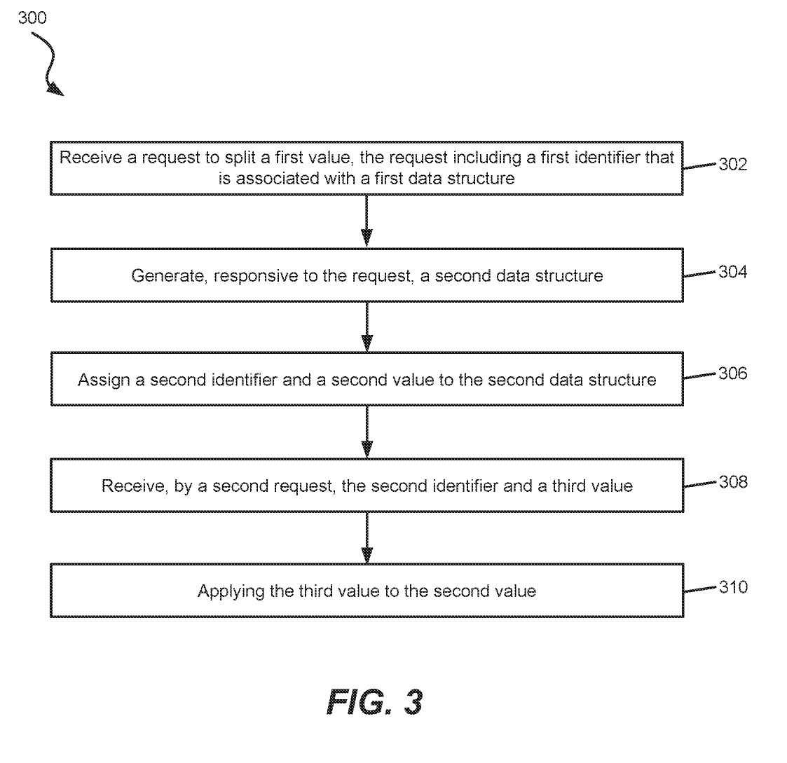

FIG. 3 illustrates a method for splitting a gift card, in accordance with various examples of the present disclosure. In some examples, the method 300 is implemented by one or more processors of the system architecture 100 or the system architecture 200, by executing computer-readable instructions to perform the functions described herein. It is understood that additional steps can be provided before, during, and after the steps of method 300, and that some of the steps described can be replaced or eliminated in other examples of the method 300.

At action 302, a transaction processor receives a request from a user interface to split a gift card. The request includes a first identifier corresponding to a gift card, which may be a gift card primary account number (PAN). The request may further identify a distribution corresponding to the gift card that provides an allocation of the gift card's prepaid value to one or more other gift cards. The received identifier corresponds to an identifier of the gift card that is stored in a data structure associated with the gift card. In some examples, the data structure is a database entry or other data structure that includes the identifier of the gift card and a prepaid value.

At action 304, the transaction processor creates one or more data structures corresponding to gift cards. For example, if the request was to split the prepaid value of the gift card into two gift cards, the transaction processor may create two data structures. Each data structure corresponds to one of the two gift cards. In some examples, the transaction processor creates a guest account corresponding to each of the gift cards, and each gift card is associated with a particular guest account. In some examples, creating a data structure includes creating an entry in a database, flat file, or other data store. For example, the data structure may include a row in a relational database that associates one or more attributes with the created gift card. These attributes may be specified in one or more columns that are mapped to the row using the relational database. In other examples, other data structures may be used.

At action 306, a second identifier is assigned to a created data structure. In the present example, the second identifier corresponds to a primary account number that is generated by the transaction processor for a second gift card. Similarly, a primary account number identifier may be generated and assigned to each of the created data structures. In addition, the transaction processor assigns a prepaid value to each of the data structures. In some examples, the user interface provides the allocation of the prepaid values. For example, a user may specify via the user interface that the user would like a $100 gift card to be split into two $50 gift cards. Accordingly, the transaction processor may create two data structures, generate two primary account number identifiers, assign a primary account number to each of the two data structures, and assign a prepaid value of $50 to each data structure (less any transaction processing fees).

In some examples, the original gift card is linked to the created gift cards, so that the transaction processor may identify the source of the created gift cards. In some examples, each data structure corresponding to a created gift card is assigned a root code that is the same as a root code of the original gift card. For example, the original gift card may specify an alphanumeric value, which may be assigned to each data structure that is generated for splitting the original gift card.

In other examples, if the transaction processor is not the issuer of the gift card, the transaction processor communicates with the issuer of the gift card to burn the gift card. A gift card may be burned by marking the gift card invalid, used, or some other marking indicating that the gift card is not accepted for processing transactions.

At action 308, the transaction processor receives a second request. The transaction processor may receive the second request from a merchant, such as a retailer, that is attempting to process a transaction corresponding to one of the created gift cards. In some examples, the second request is routed through one or more intermediaries, such that the transaction processor receives the second request from an acquirer computing system or other networked processing system, rather than from the merchant directly. The second request includes an identifier corresponding to one of the created gift cards. For example, the identifier may be the second identifier that corresponds to a primary account number that is assigned to the second data structure. In addition, the request specifies a value, which may be a value that the merchant is attempting to debit or credit to the gift card associated with the primary account number identifier. For example, the value may be a transaction amount corresponding to a purchase. The value may also include one or more processing fees. In another example, the value may be a value that the merchant is attempting to credit to the gift card, due to a return or other action that would add value to the prepaid amount assigned to the gift card.

At action 310, the transaction processor applies the value received in the second request to the prepaid value of the gift card that is associated with the second identifier. The transaction processor may apply the value to increase or decrease the prepaid value of the gift card, based on whether the request corresponds to a debit or a credit. For example, if the value corresponds to a purchase, the transaction processor may decrement the prepaid value of the gift card. Or, if the value corresponds to a return, the transaction processor may increment the prepaid value of the gift card by the value.

Certain examples of the present disclosure also relate to an apparatus for performing the operations herein. This apparatus may be constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

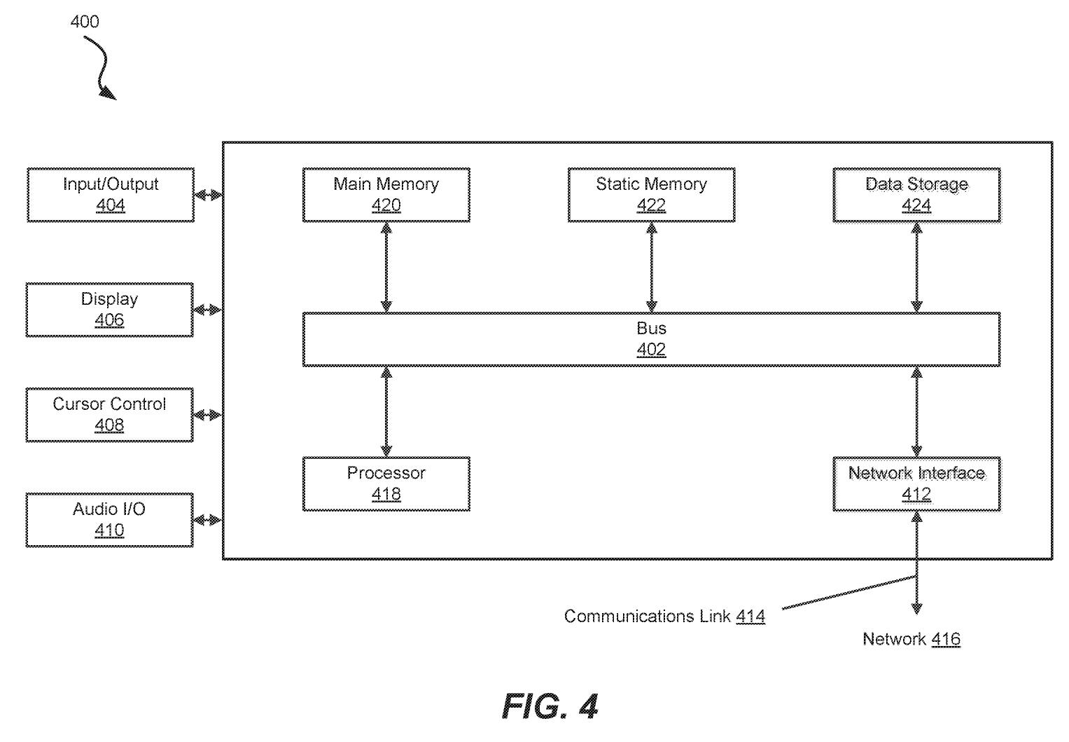

FIG. 4 illustrates a computer system 400 suitable for implementing one or more computing devices of a computing system. In various implementations, computer system 400 may provide a computing device, such as a smart or mobile phone, a computing tablet, a desktop computer, laptop, wearable device, rack mount server, or other computing device.

Computer system 400 may include a bus 402 or other communication mechanisms for communicating information data, signals, and information between various components of computer system 400. Components include an I/O component 404 that processes a user action, such as selecting keys from a keypad/keyboard, selecting one or more buttons, links, actuatable elements, etc., and sends a corresponding signal to bus 402. I/O component 404 may also include an output component, such as a display 406 and a cursor control 408 (such as a keyboard, keypad, mouse, touch screen, etc.). An optional audio I/O component 410 may also be included to allow a user to hear audio and/or use voice for inputting information by converting audio signals.

A network interface 412 transmits and receives signals between computer system 400 and other devices, such as user devices, data storage servers, transaction provider servers, and/or other computing devices via a communications link 414 and a network 416 (e.g., such as a LAN, WLAN, PTSN, and/or various other wired or wireless networks, including telecommunications, mobile, and cellular phone networks).

The processor 418 represents one or more general-purpose processing devices such as a microprocessor, central processing unit, or the like. More particularly, processor 418 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 108 may also be one or more special-purpose processing devices such as an application specific integrated circuit (ASIC), a field programmable gate array (FPGA), a digital signal processor (DSP), network processor, or the like. Processor 418 is configured to execute instructions for performing the operations and steps discussed herein.

Components of computer system 400 also include a main memory 420 (e.g., read-only memory (ROM), flash memory, dynamic random access memory (DRAM) such as synchronous DRAM (SDRAM), double data rate (DDR SDRAM), or DRAM (RDRAM), and so forth), a static memory 422 (e.g., flash memory, static random access memory (SRAM), and so forth), and a data storage device 424 (e.g., a disk drive).

Computer system 400 performs specific operations by processor 418 and other components by executing one or more sequences of instructions contained in main memory 420. Logic may be encoded in a computer readable medium, which may refer to any medium that participates in providing instructions to processor 418 for execution. Such a medium may take many forms, including but not limited to, non-volatile media, volatile media, and/or transmission media. In various implementations, non-volatile media includes optical or magnetic disks, volatile media includes dynamic memory, such as main memory 420, and transmission media between the components includes coaxial cables, copper wire, and fiber optics, including wires that comprise bus 402. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 414 to the network 416 may perform instruction sequences to practice the present disclosure in coordination with one another. Modules described herein may be embodied in one or more computer readable media or be in communication with one or more processors to execute or process the steps described herein.

It is to be understood that the above description is intended to be illustrative, and not restrictive. Many other examples will be apparent to those of skill in the art upon reading and understanding the above description. The scope of the disclosure should, therefore, be determined with reference to the appended claims, along with the full scope of equivalents to which such claims are entitled.

What is claimed is:

1. A data structure generation system, comprising:
a non-transitory memory; and
one or more hardware processors coupled to the non-transitory memory and configured to read instructions from the non-transitory memory to cause the system to perform operations comprising:
receiving a request to split a first value that corresponds to a first data structure, the request including a first identifier that is associated with the first data structure;
generating, responsive to the request, a second data structure that is assigned a same root code as the first data structure;
assigning a second identifier and a second value to the second data structure, wherein the second value is less than the first value;
receiving, by a second request, the second identifier and a third value; and
reducing the third value by the second value.

2. The system of claim 1, the operations further comprising:
generating, responsive to the request, a third data structure that is assigned a third identifier and a fourth value, wherein the fourth value is less than the first value.

3. The system of claim 1, wherein the second request is to process a transaction having a transaction amount that is equal to the third value, and wherein the transaction is processed from a gift card that is assigned the second identifier.

4. The system of claim 1 wherein the first identifier corresponds to a primary account number of a first gift card, wherein the second identifier corresponds to a primary account number of a second gift card.

5. The system of claim 2, wherein a sum of the second value, the fourth value, and one or more processing fees is equal to the first value.

6. The system of claim 1, wherein the second data structure is mapped to the first data structure.

7. The system of claim 1, wherein the root code is an alphanumeric value that is assigned to the first data structure and the second data structure.

8. A non-transitory machine-readable medium having stored thereon machine-readable instructions executable to cause a machine to perform operations comprising:
receiving a request to split a first value that corresponds to a first data structure, the request including a first identifier that is associated with the first data structure;
generating, responsive to the request, a second data structure;
assigning a second identifier and a second value to the second data structure, wherein the second value is less than the first value;
receiving, by a second request, the second identifier and a third value; and
reducing the third value by the second value.

9. The non-transitory machine-readable medium of claim 8, the operations further comprising:
generating, responsive to the request, a third data structure that is assigned a third identifier and a fourth value, wherein the fourth value is less than the first value.

10. The non-transitory machine-readable medium of claim 8, wherein the second request is to process a transaction having a transaction amount that is equal to the third value, and wherein the transaction is processed from a gift card that is assigned the second identifier.

11. The non-transitory machine-readable medium of claim 8, wherein the first identifier corresponds to a primary account number of a first gift card, wherein the second identifier corresponds to a primary account number of a second gift card.

12. The non-transitory machine-readable medium of claim 9, wherein a sum of the second value, the fourth value, and one or more processing fees is equal to the first value.

13. The non-transitory machine-readable medium of claim 8, wherein the second data structure is assigned a same root code as the first data structure that is associated with the first identifier.

14. The non-transitory machine-readable medium of claim 8, wherein the second data structure is mapped to the first data structure.

15. A method comprising:
receiving a request to split a first value that corresponds to a first data structure, the request including a first identifier that is associated with the first data structure;
generating, responsive to the request, a second data structure;
assigning a second identifier and a second value to the second data structure, wherein the second value is less than the first value;
receiving, by a second request, the second identifier and a third value; and
reducing the third value by the second value.

16. The method of claim 15, generating, responsive to the request, a third data structure that is assigned a third identifier and a fourth value, wherein the fourth value is less than the first value.

17. The method of claim 15, wherein the second request is to process a transaction having a transaction amount that is equal to the third value, and wherein the transaction is processed from a gift card that is assigned the second identifier.

18. The method of claim 15, wherein the first identifier corresponds to a primary account number of a first gift card, wherein the second identifier corresponds to a primary account number of a second gift card.

19. The method of claim 16, wherein a sum of the second value, the fourth value, and one or more processing fees is equal to the first value.

20. The method of claim 15, wherein the second data structure is assigned a same root code as the first data structure that is associated with the first identifier.
